(19) United States
(12) Patent Application Publication
(10) Pub. No.: US 2013/0229009 A1
(43) Pub. Date: Sep. 5, 2013

(54) INFORMATIONAL LABEL FOR A HEATING,VENTILATION AND AIR CONDITIONING COMPONENT

(71) Applicant: CARRIER CORPORATION, Farmington, CT (US)

(72) Inventors: Nitu Gupta, Westfield, IN (US); Larry D. Rieke, Zionsville, IN (US)

(73) Assignee: CARRIER CORPORATION, Farmington, CT (US)

(21) Appl. No.: 13/782,276

(22) Filed: Mar. 1, 2013

Related U.S. Application Data
(60) Provisional application No. 61/605,257, filed on Mar. 1, 2012.

(51) Int. Cl. B42D 15/00

(52) U.S. Cl. CPC B42D 15/00
USPC 283/81

(57) ABSTRACT

An informational label for a component of a heating ventilation and air conditioning (HVAC) unit includes a sheet including a plurality of panels foldable from an opened configuration into a closed configuration. The sheet exhibits at least one of resistance to heat or resistance to moisture of an operating environment. A closure is utilized to secure the plurality of panels in the closed configuration, and a layer of adhesive is applied to a panel of the plurality of panels to secure the informational label to an HVAC component.

### CROSS REFERENCE TO RELATED APPLICATION

This application claims priority to U.S. provisional application, 61/605,257, filed Mar. 1, 2012, the entire contents of which are incorporated herein by reference.

### BACKGROUND OF THE INVENTION

The subject matter disclosed herein relates to heating, ventilation and air conditioning (HVAC) units. More specifically, the subject matter disclosed herein relates to informational labels applied to HVAC components.

Residential HVAC components, for example, furnaces must comply with regulatory requirements, which include the inclusion of installation, operation and safety information printed on labels and affixed to various components of the furnace. Such labels are required to stay with the furnace and may not be removed. As they are often affixed to various components of the furnace, the information may be difficult to find when needed. Further, as requirements for label information have increased, requiring larger labels to be affixed to the furnace, the desire for energy efficiency of furnaces has driven down furnace size, resulting in fewer and/or smaller locations to affix the required labels.

### BRIEF DESCRIPTION OF THE INVENTION

In one embodiment, an informational label for a heating, ventilation and air conditioning (HVAC) component includes a sheet including a plurality of panels foldable from an opened configuration into a closed configuration. The sheet exhibits at least one of resistance to heat or resistance to moisture of an operating environment. A closure is utilized to secure the plurality of panels in the closed configuration, and a layer of adhesive is applied to a panel of the plurality of panels to secure the informational label to an HVAC component.

In another embodiment, a furnace includes a housing and one or more furnace components located in the housing. The housing includes a door removable from the housing and an informational label affixed to the door. The informational label includes a sheet including a plurality of panels foldable from an opened configuration into a closed configuration. The sheet exhibits at least one of resistance to heat or resistance to moisture of an operating environment. A closure is utilized to secure the plurality of panels in the closed configuration, and a layer of adhesive is applied to a panel of the plurality of panels to secure the informational label to the door.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is an embodiment of a furnace;

FIG. 2 is an embodiment of a blower door for a furnace; and

FIG. 3 is an embodiment of an informational booklet for a furnace.

The detailed description explains embodiments of the invention, together with advantages and features, by way of example with reference to the drawings.

### DETAILED DESCRIPTION OF THE INVENTION

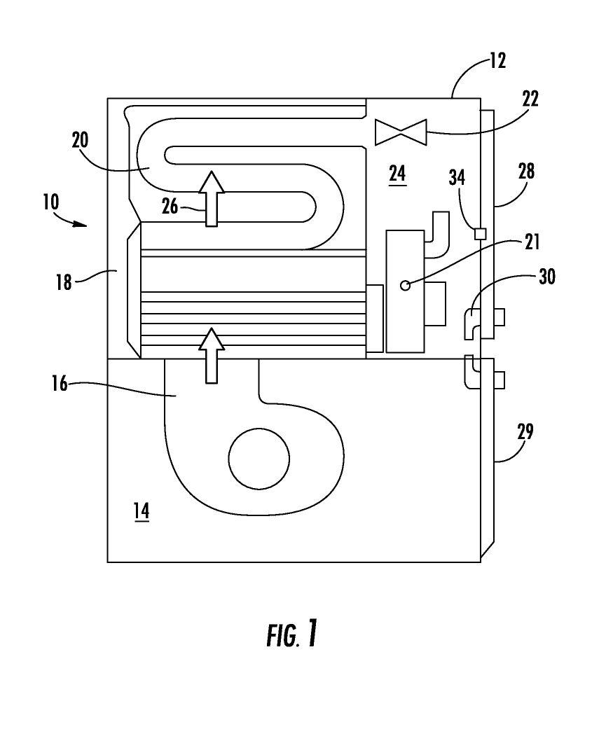

Shown in FIG. 1 is an embodiment of a furnace 10, in this embodiment a gas-powered furnace 10. Even though the invention herein is described as applied to a furnace 10, other components of a heating ventilation and air conditioning (HVAC) unit, such as an air conditioner or a heat pump, would benefit from the present disclosure. The furnace 10 comprises a housing 12. The housing 12 includes three primary chambers, a blower chamber 14 containing a blower 16, a heat exchange chamber 18 containing a heat exchanger 20 and a burner assembly 22, and a control chamber 24 or vestibule chamber, containing an inducer 21 and the burner assembly 22. The burner assembly 22 heats the heat exchanger 20, and the inducer 21 draws flue gas through the heat exchanger 20. The blower 16 blows an air flow 26 across the heat exchanger 20, thermal energy is transferred from the heat exchanger 20 to the air flow 26.

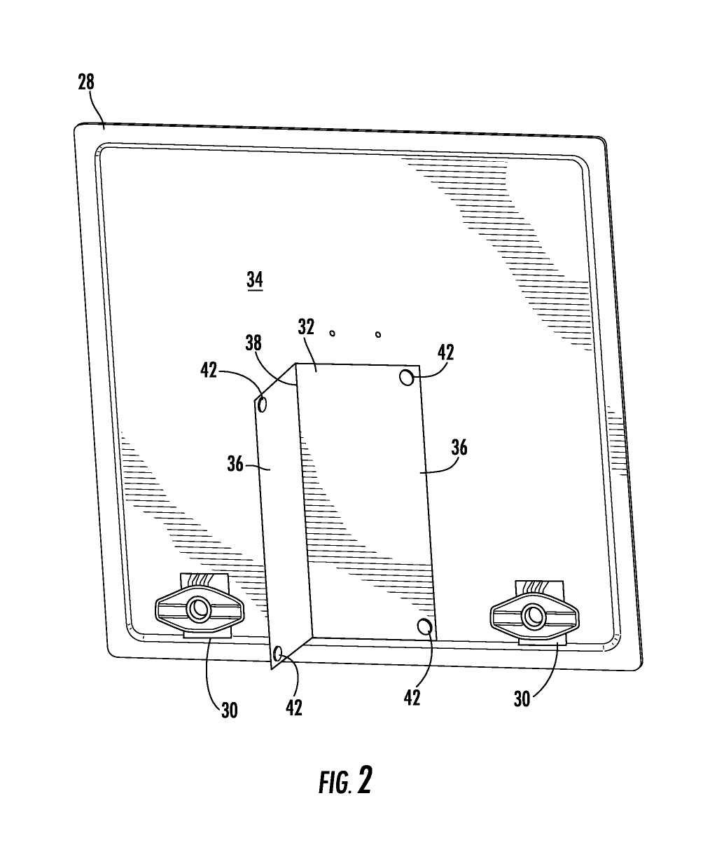

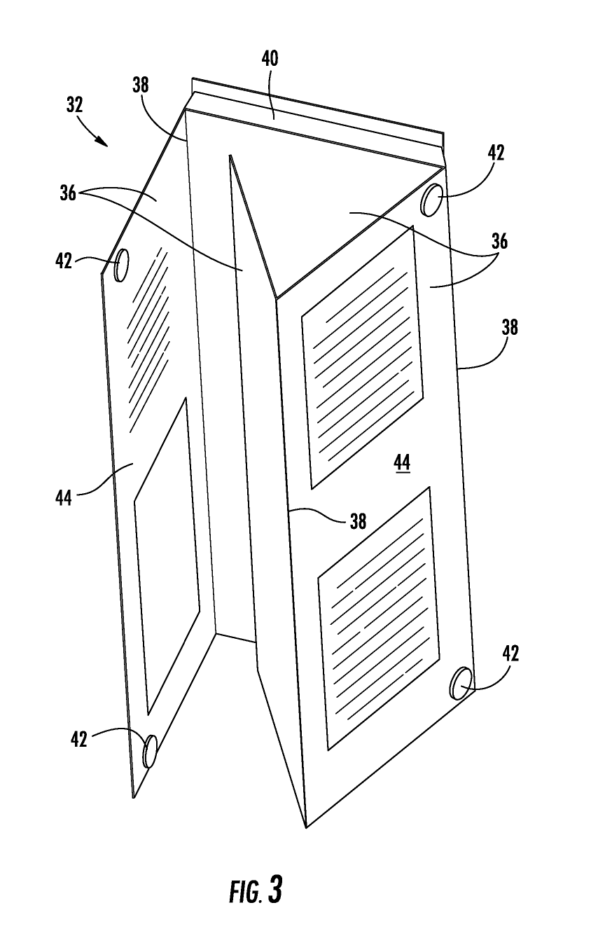

The housing 12 includes a number of removable doors, for example, blower door 29 to provide access to the blower 16 for service and/or repair and control door 28 to provide access to the burner assembly 22, the inducer 21 and other components of the furnace 10 for initial set up and adjustment, service and/or repair. The other components may include, for example, gas valves, 115V electrical connections, vent connection, drain connection, or the like. The control door 28 is removed by opening one or more control door latches 30, which secure the control door 28 to the housing 12. Referring to FIG. 2, an information booklet 32 is affixed to an interior side 34 of the control door 28. The booklet 32 is a single sheet having multiple panels 36 folded at seams 38 to form booklet 32. It is to be appreciated that while a single-sheet booklet is illustrated and described herein, that multiple-sheet booklets 32 are within the scope of the present disclosure. As an example, the booklet 32 shown in FIG. 3 includes four panels 36 and three seams 38 folded to form booklet 32. One panel 36 of the panels 36 is secured to the control door 28 with, for example, a layer of pressure-sensitive adhesive 40. In one embodiment the adhesive 40 is a 300 LSE adhesive transfer tape commercially available from 3M™. In one embodiment, the pressure sensitive adhesive 40 adheres the booklet 32 to the control door 28 to withstand about a 25 pound pull force on the booklet 32 to prevent removal of the booklet 32 from the control door 28. Further, the adhesive 40 is able to withstand the high temperature of the blower chamber 14. Securing a single panel 36 to the control door 28 allows the booklet 32 to be folded into a relatively small size, as shown in FIG. 2, enabling the booklet 32 to fit into a smaller space than a single unfolded sheet of labels. Further, as lighting is often poor in areas where furnaces 10 are installed, with the booklet 32 secured to the blower door 28, the control door 28 can be removed from the furnace 10 and the control door 28 together with the booklet 32 may be carried to a location with adequate lighting for easier reading of information printed in the booklet 32.

The booklet 32 is secured in a closed configuration by one or more hook and loop closures 42. The embodiment shown includes two hook and loop closures 42, but it is to be appreciated that other quantities of closures 42 may be utilized. In one embodiment, the hook and loop closure is a Hook 88 and Loop 1000 closure commercially available from Velcro®. Further, other types of closures 42, for example, magnetic closures, may be utilized. Securing the booklet 32 with the closures 42 allows for easier handling of the booklet 32 and prevents the booklet 32 from contacting internal components of the furnace 10, for example, the inducer 21 or the burner assembly 22.

Referring again to FIG. 3, panels 36 are printed with necessary and/or selected information related to the furnace 10. In some embodiments, this information includes safety information, operating instructions, service instructions, electrical connection diagrams, schematic diagrams, and/or installation instructions. The panels 36 may be printed with such information on either or both sides 44 of the panels 36. Printing on two sides 44, however, allows for more information to be printed on a booklet 32 of a given size, or stated another way, allows for the same information to be printed on a smaller booklet 32. The booklet 32 material and printing thereon is capable of withstanding chemical exposure to those typically encountered in the furnace 10 environment, is resistant to prolonged heat exposure such as about 2 weeks and 250 degrees Fahrenheit, and immersion in water. In some embodiments, the booklet 32 is formed from a PRO-Print® Synthetic Paper or Igneous™ Paper.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An informational label for a component of a heating ventilation and air conditioning (HVAC) unit comprising:
a sheet including a plurality of panels foldable from an opened configuration into a closed configuration, the sheet exhibiting at least one of resistance to heat or resistance to moisture of an operating environment;
a closure to secure the plurality of panels in the closed configuration; and
a layer of adhesive applied to a panel of the plurality of panels to secure the informational label to an HVAC component.

2. The informational label of claim 1, wherein the HVAC component is a furnace.

3. The informational label of claim 1, wherein the closure is at least one hook and loop closure.

4. The informational label of claim 1, wherein the closure is disposed at a corner of a panel of the plurality of panels.

5. The informational label of claim 1, wherein the adhesive is a pressure-sensitive adhesive.

6. The informational label of claim 1, wherein the adhesive secures the informational label to the furnace component to withstand a pull force of about 25 pounds on the informational label.

7. The informational label of claim 1, wherein the plurality of panels is four panels.

8. The informational label of claim 1, wherein the sheet is resistant to damage by prolonged temperature exposure up to about 250 degrees Fahrenheit.

9. The informational label of claim 1, wherein the sheet is resistant to damage due to water immersion.

10. The informational label of claim 1, wherein information is printed on one or more faces of the sheet.

11. A furnace comprising:
a housing;
one or more furnace components disposed in the housing;
a door removable from the housing;
an informational label affixed to the door including:
a sheet including a plurality of panels foldable from an opened configuration into a closed configuration, the sheet exhibiting at least one of resistance to heat or resistance to moisture of an operating environment;
a closure to secure the plurality of panels in the closed configuration; and
a layer of adhesive applied to a panel of the plurality of panels to secure the informational label to the door.

12. The furnace of claim 11, wherein the door is a control door or a blower door.

13. The furnace of claim 11, wherein the door is removable from the housing by opening one or more door latches.

14. The furnace of claim 11, wherein the closure is at least one hook and loop closure.

15. The furnace of claim 11, wherein the closure is disposed at a corner of a panel of the plurality of panels.

16. The furnace of claim 11, wherein the adhesive is a pressure-sensitive adhesive.

17. The furnace of claim 11, wherein the adhesive secures the informational label to the door to withstand a pull force of about 25 pounds on the informational label.

18. The furnace of claim 11, wherein the plurality of panels is four panels.

19. The furnace of claim 11, wherein the sheet is resistant to damage by prolonged temperature exposure up to about 250 degrees Fahrenheit.

20. The furnace of claim 11, wherein the sheet is resistant to damage due to water immersion.
